(19) United States
(12) Patent Application Publication
(10) Pub. No.: US 2016/0294305 A1
(43) Pub. Date: Oct. 6, 2016

(54) TRIBOELECTRIC ENERGY HARVESTER

(71) Applicant: RESEARCH & BUSINESS FOUNDATION SUNGKYUNKWAN UNIVERSITY, Suwon-si (KR)

(72) Inventors: Sang Woo KIM, Yongin-si (KR); Sung Soo KWAK, Seongnam-si (KR); Sang Hyun KIM, Seongnam-si (KR); Seong Su KIM, Seoul (KR); Tae Yun KIM, Incheon (KR); Tae Ho KIM, Seoul (KR); Wan Chul SEUNG, Yongin-si (KR); Han Jun RYU, Daejeon (KR); Hong Joon YOON, Goyang-si (KR); Jeong-Hwan LEE, Gumi-si (KR); Ju-Hyuck LEE, Suwon-si (KR)

(73) Assignee: RESEARCH & BUSINESS FOUNDATION SUNGKYUNKWAN UNIVER SITY, Suwon-si (KR)

(21) Appl. No.: 15/089,869

(22) Filed: Apr. 4, 2016

(30) Foreign Application Priority Data
Apr. 2, 2015 (KR) 10-2015-0046957

(51) Int. Cl. H02N 1/04

(52) U.S. Cl. CPC H02N 1/04

(57) ABSTRACT

A triboelectric energy harvester comprises an electrode, a non-conductor, a first conductor, and a second conductor. The non-conductor is disposed on the electrode. The first conductor is disposed on the non-conductor. The second conductor frictionally contacts the first conductor. The frictional contact between the first and second conductors creates triboelectric energy.

### CROSS-REFERENCE TO RELATED APPLICATION

This application claims the benefit under 35 USC 119(a) of Korean Patent Application No. 10-2015-0046957 filed on Apr. 2, 2015, in the Korean Intellectual Property Office, the entire disclosure of which is incorporated herein by reference for all purposes.

### BACKGROUND

1. Field

The present disclosure relates to a triboelectric energy harvester using frictional contact between different conductors, and more particularly, to a structure of the harvester.

2. Description of Related Art

Energy harvesters using friction-to-electric conversion is an eco-friendly electric-generator that converts wasted mechanical energy, resulting from human movement or external microscopic vibrations, to electric energy.

Energy conversion using the triboelectric property has large energy conversion efficiency and enables a light weight generator. When a triboelectric energy harvester employs nanotechnology, it may have great influence on future energy harvesting. Triboelectric energy harvester employs static electricity resulting from frictional contact. In other words, contact and separation or frictional contact between two different materials may cause the static electricity, which in turn may cause a difference between electric charges for the two materials to generate triboelectric energy.

Conventionally, a triboelectric energy harvester employs contact and separation between a conductor and a non-conductor, or different non-conductors. In this configuration, the prior art triboelectric energy harvester is limited in terms of use.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a triboelectric energy harvester comprises an electrode, a non-conductor, a first conductor, and a second conductor. The non-conductor is disposed on the electrode. The first conductor is disposed on the non-conductor. The second conductor frictionally contacts the first conductor. The frictional contact between the first and second conductors creates triboelectric energy.

The triboelectric energy harvester may further comprise a substrate disposed on the second conductor.

The triboelectric energy harvester may further comprise current collection lines coupled to the electrode, the second conductor, and an energy storage device.

The triboelectric energy harvester may further comprise rectifier diodes coupled to the current collection line between the electrode and the energy storage, and between the second conductor and the energy storage.

In another general aspect, a triboelectric energy harvester comprises a lower electrode, a lower non-conductor, a lower conductor, an upper conductor, an upper non-conductor, and an upper electrode. The lower non-conductor is disposed on the lower electrode. The lower conductor is disposed on the lower non-conductor. The upper conductor opposes the lower conductor to be in contact or be separated from the lower conductor in a repeated manner. The upper non-conductor is disposed on the upper conductor. The upper electrode is disposed on the upper non-conductor. A combination of contact and subsequent separation between the lower and upper conductors creates triboelectric energy.

The triboelectric energy harvester may further comprise current collection lines coupled to the lower electrode, the upper electrode, and an energy storage.

The triboelectric energy harvester may further comprise rectifier diodes coupled to the current collection line between the lower electrode and the energy storage, and between the upper electrode and the energy storage.

In another general aspect, a triboelectric energy harvester, comprises a first plurality of layers, a second plurality of layers, and an energy storage device. The first plurality of layers comprises alternating conductor and dielectric layers. The second plurality of layers comprises alternating conductor and dielectric layers. The first plurality of layers has a first surface in frictional contact with a first surface of the second plurality of layers. The energy storage device is electrically coupled between the first plurality of layers and the second plurality of layers. The frictional contact creates electric current that flows into the energy storage device.

The triboelectric energy harvester may have the first surface of the first plurality of layers and the first surface of the second plurality of layers be conductors.

The triboelectric energy harvester may have a second surface of the first plurality of layers and a second surface of the second plurality of layers be conductors.

The triboelectric energy harvester may have a second surface of the first plurality of layers be dielectric and a second surface of the second plurality of layers be a conductor.

In another general aspect, a triboelectric generator comprises a first stack of layers and a second stack of layers. The first stack of layers comprises a first non-conductor layer disposed between a first conductor layer and a first electrode layer. The second stack of layers comprises a second non-conductor layer disposed between a second electrode layer and a second conductor layer. Triboelectric charging is created when the first conductor layer frictionally contacts the second conductor layer.

The first and second conductors may be made of different materials. The lower and upper conductors may be different materials. The first surface of the first plurality of layers and the first surface of the second plurality of layers may be made of different materials. The first conductor layer and the second conductor layer may be made of different materials. The materials may be chosen on their relative separation in a triboelectric series list.

Other features and aspects will be apparent from the following detailed description, the drawings, and the claims.

### BRIEF DESCRIPTIONS OF THE DRAWINGS

FIG. 1 illustrates an example of a schematic view of a triboelectric energy harvester using frictional contact between different conductors.

FIG. 2 illustrates another example of a schematic view of a triboelectric energy harvester using frictional contact between different conductors.

FIG. 3 illustrates a schematic view of an example of a triboelectric energy harvester using frictional contact between different conductors.

FIG. 4A illustrates a schematic view of an example of electron travel when different conductors are in contact with each other in a triboelectric energy harvester.

FIG. 4B illustrates a schematic view of an example of electron travel when different conductors are separated from each other in a triboelectric energy harvester.

FIG. 5 depicts graphs indicating voltage and current measurements for triboelectric energy generated in a triboelectric energy harvester.

FIG. 6 depicts graphs indicating voltage and current measurements for triboelectric energy generated in a prior art triboelectric energy harvester.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTIONS

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Unless indicated otherwise, a statement that a first layer is “on” a second layer or a substrate is to be interpreted as covering both a case where the first layer directly contacts the second layer or the substrate, and a case where one or more other layers are disposed between the first layer and the second layer or the substrate.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation,

Expressions such as “first conductivity type” and “second conductivity type” as used herein may refer to opposite conductivity types such as N and P conductivity types, and examples described herein using such expressions encompass complementary examples as well. For example, an example in which a first conductivity type is N and a second conductivity type is P encompasses an example in which the first conductivity type is P and the second conductivity type is N.

Hereinafter, embodiments of the present disclosure will be described in details with reference to attached drawings.

When the different conductors are in frictional contact with each other, an electric circuit therebetween to allow surface charges to flow between the different conductors. In other words, when the different conductors are in frictional contact with each other, an electric short circuit between the different conductors limits the surface charges resulting from the triboelectric event to act as an energy source.

The surface charges resulting from frictional contact between different conductors may not be used as an energy source due to the short circuit between the conductors. However, the disclosed approaches overcome this problem and allow triboelectric energy resulting from the frictional contact between different conductors to be available as the energy source. To this end, in accordance with the present disclosure, the triboelectric energy harvester may be configured to have opposing first and second conductors to contact each other, and have a non-conductor disposed on one of the first and second conductors, and a third conductor disposed on the non-conductor. In another example, the triboelectric energy harvester may be configured to have opposing first and second conductors to contact each other, and have a first non-conductor disposed on the first conductor, a third conductor disposed on the first non-conductor, a second non-conductor disposed on the second conductor, a fourth conductor disposed on the second non-conductor. In the configurations as disclosed, in the former case, the third conductor prevents a short circuit, and, in the latter case, the third and fourth conductors prevent the short circuit. Hereinafter, configurations of the triboelectric energy harvester using frictional contact between different conductors in accordance will be described in detail.

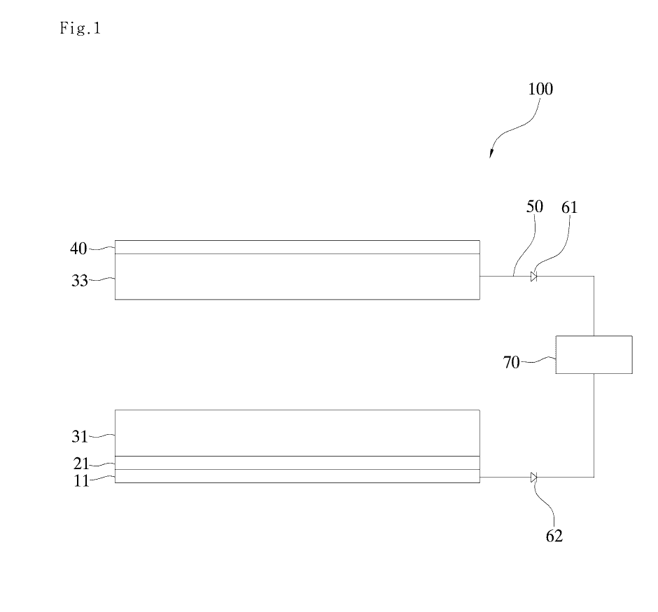

FIG. 1 illustrates an example of a schematic view of a triboelectric energy harvester using frictional contact between different conductors.

The triboelectric energy harvester 100 in FIG. 1 includes a first electrode 11, a non-conductor 21 disposed on the first electrode 11, and a first conductor 31 disposed on the non-conductor 21. A second conductor 33 is displaced from the first conductor 31 in an opposing manner. During use, frictional contact (or contact and separation) between the first and second conductors 31 and 33 occur to create contact electrification when the first conduct 31 and the second conductor 33 become electrically charged. The first and second conductors 31 and 33 are made of different materials.

The first electrode 11 is not limited to any type of material and configuration as long as it can serve as an electrical conductor. The non-conductor 21 is also not limited to any material and configuration as long as it can serve as an electrical insulator. The non-conductor 21 may be thin and has a high dielectric constant.

During use, the first conductor 31 and second conductor 33 are in contact each other and then moved back and forth along the contact surface while maintaining the contact. The first conductor 31 and the second conductor 33 are not be limited in terms of material and configuration as long as they can serve as an electrical conductor. The first conductor 31 and second conductor 33 should be made of different materials. In this configuration, the first conductor 31 and second conductor 33 have different charging properties, which means that the first conductor 31 and second conductor 33 are located at different positions in a triboelectric series. Triboelectric series list materials in order of polarity of charge separation when touched with another object. It may be preferable that the different relative positions in the triboelectric series be more distant from each other, which means that the difference between the charging properties of the first conductor 31 and second conductor 33 will be larger as the distance grows. The larger difference leads to a larger triboelectric amount.

Referring to FIG. 1, when the first conductor 31 and the second conductor 33 are in frictional contact and/or rubbed together, triboelectric energy is created. The contact electrification shown in FIG. 1 is not limited thereto. For example, ways of frictional contact may include, contact and separation, bending, sliding, and pushing of the first conductor 31 against the second conductor 33, or vice versa.

A substrate 40 is disposed on the second conductor 33 for support. The substrate 40 is not limited in terms of material and configuration as long as it can serve as a support member.

The first electrode 11, first non-conductor 21, and the first conductor 31 are contiguously disposed each to the other. The second conductor 33 and the substrate 40 are also contiguously disposed each to the other.

To harness the triboelectric energy resulting from the frictional contact between the first conductor 31 and second conductor 33, a current collection line 50 is connected between the first electrode 11 and the second conductor 33. The current collection line 50 is also used to connect energy storage 70 between the first electrode 11 and the second conductor 33. As shown in FIG. 1, the current collection line 50 is used to connect a rectifier diode 61 between the second conductor 33 and the energy storage 70. Further, between the electrode 11 and the energy storage 70, the current collection line 50 is used to connect another rectifier diode 62.

The current collection line 50 may be construed to include the electrode 11. The current collection line 50 may be electrically coupled to the energy storage 70 such as a battery. Between the current collection line 50 and energy storage 70, one or more rectifier diodes (not shown) may be further disposed. The current collection line 50 may be coupled to electrically power an electrical device such as a lamp. The rectifier diodes 61, 62 may act to enable current flow in a single direction to prevent the current from back-flowing and thus to prevent the battery from being discharged.

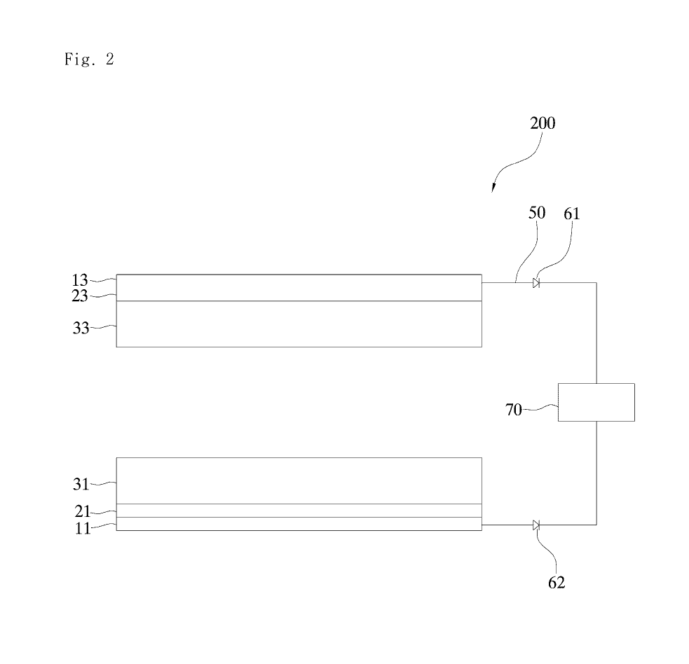

FIG. 2 illustrates another example of a schematic view of a triboelectric energy harvester using frictional contact between different conductors.

A difference in the configuration between the examples of FIG. 1 and FIG. 2 is that, in the FIG. 1, the second conductor 33 itself acts as the electrode. In the example depicted in FIG. 2, a non-conductor 23 is disposed between the second conductor 33 and an electrode 13.

The triboelectric energy harvester 200 in FIG. 2 includes a first non-conductor 21 disposed between on a first electrode 11 and a first conductor 31. A second conductor 33 is displaced from the first conductor 31 in an opposing manner. During use, fictional contact (or contact and separation) between the first and second conductors 31 and 33 occur to create contact electrification when the first conduct 31 and the second conductor 33 become electrically charged. The first and second conductors 31 and 33 are made of different materials. A second non-conductor 23 disposed between the second conductor 33 and a second electrode 13. The first electrode 11, first non-conductor 21, and the first conductor 31 are contiguously disposed each to the other. The second conductor 33, the second non-conductor 23, and second electrode 13 are also contiguously disposed each to the other.

The first and second electrodes 11 and 13 are not limited in terms of material and configuration as long as they can serve as an electrical conductor. The first and second non-conductors 21 and 23 are not limited in terms of a material and configuration as long as they can serve as an electrical insulator. The first and second non-conductors 21 and 23 may be thin and have a high dielectric constant.

The opposing first conductor 31 and second conductor 33 are in contact or separated with each other. The first conductor 31 and the second conductor 33 are not limited in terms of a material and configuration as long as they can serve as an electrical conductor. The first conductor 31 and the second conductor 33 should be made of different materials. In this configuration, the first conductor 31 and the second conductor 33 have different charging properties, which means that the first conductor 31 and second conductor 33 are located at different positions in a triboelectric series. It may be preferable that the different relative positions in the triboelectric series be more distant from each other, which means that the difference between the charging properties of the first conductor 31 and second conductor 33 will be larger as the distance grows. The larger difference leads to a larger triboelectric amount.

Referring to FIG. 2, when the first conductor 31 and the second conductor 33 are in frictional contact and/or rubbed together, triboelectric energy is created. The contact electrification shown in FIG. 2 is not limited thereto. For example, frictional contact may include, contact and separation, bending, sliding, and pushing of the first conductor 31 against the second conductor 33.

To harness the triboelectric energy resulting from the frictional contact between the first conductor 31 and second conductor 33, a current collection line 50 is connected to the first and second electrodes 11 and 13. The current collection line 50 is also used to connect an energy storage 70 between the first electrode 11 and the second conductor 33. The current collection line 50 is used to connect a rectifier diode 61 between the second electrode 13 and the energy storage 70. Further, between the first electrode 11 and the energy storage 70, the current collection line 50 is used to connect another rectifier diode 62.

The current collection line 50 may be construed to include the first electrode 11 and/or the second electrodes 13. The current collection line 50 may be electrically coupled to the energy storage 70 such as a battery. Between the current collection line 50 and energy storage 70, one or more rectifier diodes (not shown) may be further disposed. The current collection line 50 may electrically power an electrical device such as a lamp. The rectifier diodes 61, 62 may act to enable current to flow in a single direction to prevent the current from back-flowing and thus to prevent the battery from being discharged.

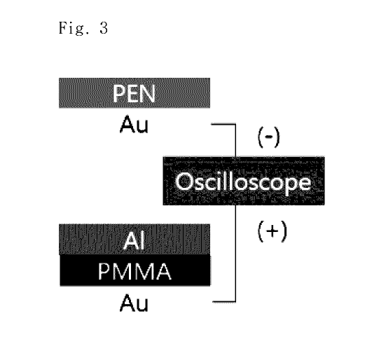

FIG. 3 illustrates a schematic view of an example of a triboelectric energy harvester using frictional contact between different conductors.

The example of the triboelectric energy harvester in FIG. 3 includes a gold (Au) electrode as a first electrode (lower electrode in the figure), a polymethyl methacrylate (PMMA) non-conductor disposed on the first electrode, and an aluminum (Al) electrode disposed on the PMMA electrode as a first conductor. In this configuration, the example further includes an Au second conductor, and a polyethylene naphthalate (PEN) substrate on the second conductor to support the second conductor.

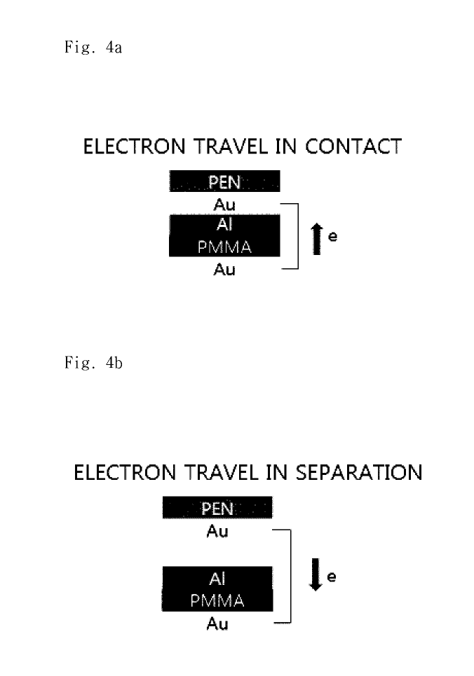

FIG. 4A illustrates a schematic view of an example of electron “e” travel when different conductors are in contact with each other in a triboelectric energy harvester. FIG. 4B illustrates a schematic view of an example of electron “e” travel when different conductors are separated from each other in a triboelectric energy harvester. In accordance with the present disclosure, when separate non-conductor(s) and electrode(s) are disposed on one (or both) of the two opposing different conductors, triboelectric energy can efficiently be harvested via friction between the facing different conductors.

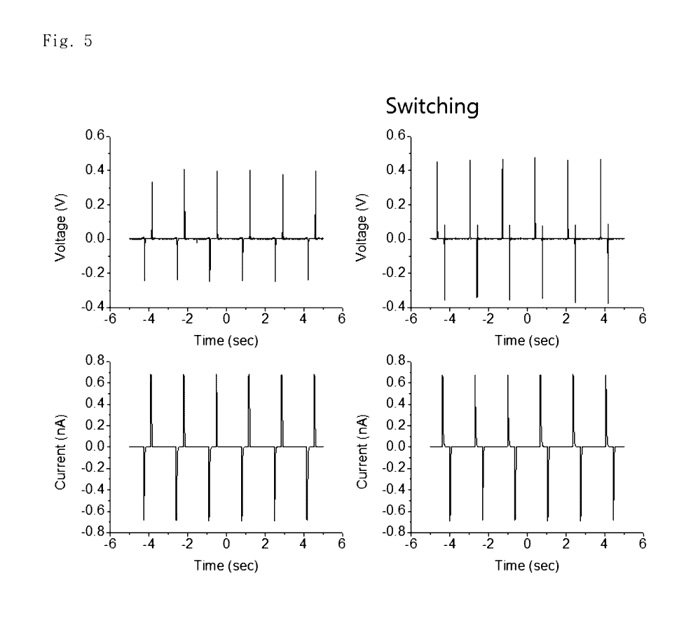

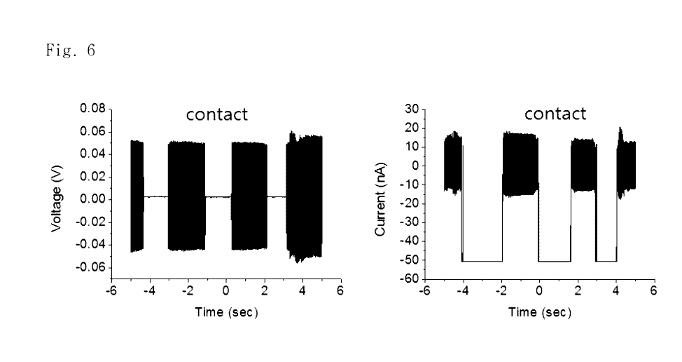

FIG. 5 shows a graph indicating voltage and current measurements for triboelectric energy generated in a triboelectric energy harvester. FIG. 6 shows a graph indicating voltage and current measurements for triboelectric energy generated in a prior art triboelectric energy harvester. Comparing FIG. 5 to FIG. 6, voltages and currents peak in FIG. 5 but not in FIG. 6.

As shown in FIG. 6, which represents triboelectric energy harvesters in the prior art, in an instance where opposing different conductors frictionally contact each other, noisy peaks occur due to separated non-conductor and electrode being present.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A triboelectric energy harvester comprising:
an electrode;
a non-conductor disposed on the electrode;
a first conductor disposed on the non-conductor; and
a second conductor frictionally contacting the first conductor, wherein the frictional contact between the first and second conductors creates triboelectric energy.

2. The triboelectric energy harvester of claim 1, further comprising a substrate disposed on the second conductor.

3. The triboelectric energy harvester of claim 1, further comprising current collection lines coupled to the electrode, the second conductor, and an energy storage device.

4. The triboelectric energy harvester of claim 3, further comprising rectifier diodes coupled to the current collection line between the electrode and the energy storage, and between the second conductor and the energy storage.

5. A triboelectric energy harvester comprising:
a lower electrode;
a lower non-conductor disposed on the lower electrode;
a lower conductor disposed on the lower non-conductor;
an upper conductor opposing the lower conductor to be in contact or be separated from the lower conductor in a repeated manner;
an upper non-conductor disposed on the upper conductor; and
an upper electrode disposed on the upper non-conductor,
wherein a combination of contact and subsequent separation between the lower and upper conductors creates triboelectric energy.

6. The triboelectric energy harvester of claim 5, further comprising current collection lines coupled to the lower electrode, the upper electrode, and an energy storage.

7. The triboelectric energy harvester of claim 6, further comprising rectifier diodes coupled to the current collection line between the lower electrode and the energy storage, and between the upper electrode and the energy storage.

8. A triboelectric energy harvester, comprising:
a first plurality of layers comprising alternating conductor and dielectric layers;
a second plurality of layers comprising alternating conductor and dielectric layers, the first plurality of layers having a first surface in frictional contact with a first surface of the second plurality of layers; and
an energy storage device electrically coupled between the first plurality of layers and the second plurality of layers,
wherein the frictional contact creates electric current that flows into the energy storage device.

9. The triboelectric energy harvester of claim 8, wherein the first surface of the first plurality of layers and the first surface of the second plurality of layers are conductors.

10. The triboelectric energy harvester of claim 9, wherein a second surface of the first plurality of layers and a second surface of the second plurality of layers are conductors.

11. The triboelectric energy harvester of claim 9, wherein a second surface of the first plurality of layers is dielectric and a second surface of the second plurality of layers is a conductor.

12. A triboelectric generator, comprising:
a first stack of layers comprising a first non-conductor layer disposed between a first conductor layer and a first electrode layer;
a second stack of layers comprising a second non-conductor layer disposed between a second electrode layer and a second conductor layer,
wherein triboelectric charging is created when the first conductor layer frictionally contacts the second conductor layer.

13. The triboelectric energy harvester of claim 1, wherein the first and second conductors are made of different materials.

14. The triboelectric energy harvester of claim 5, wherein the lower and upper conductors are made of different materials.

15. The triboelectric energy harvester of claim 9, wherein the first surface of the first plurality of layers and the first surface of the second plurality of layers are made of different materials.

16. The triboelectric energy generator of claim 12, wherein the first conductor layer and the second conductor layer are made of different materials.
